(19) United States
(12) Patent Application Publication
(10) Pub. No.: US 2026/0359779 A1
(43) Pub. Date: Nov. 12, 2026

(54) COMPONENT ORDERING SYSTEM AND METHOD THEREFOR

(71) Applicants: Hyundai Motor Company, Seoul (KR); Kia Corporation, Seoul (KR)

(72) Inventors: Young Seok Jin, Seoul (KR); Sun Hoon KIM, Seoul (KR); Hyun Dong Park, Gyeonggi-do (KR)

(21) Appl. No.: 19/109,199

(22) PCT Filed: Dec. 20, 2022
(86) PCT No.: PCT/KR2022/020791

§ 371 Date: Mar. 6, 2025

(30) Foreign Application Priority Data
Sep. 27, 2022 (KR) 10-2022-0122702

(51) Int. Cl. G06Q 10/087; G06Q 10/0833

(52) U.S. Cl. CPC G06Q 10/087; G06Q 10/0833

(57) ABSTRACT

Proposed are a component ordering system and a method therefor. The component ordering system includes a necessary lead time calculation part configured to calculate, on the basis of prestored order data, a necessary lead time required for each component, a safety lead time calculation part configured to calculate a safety lead time satisfying customer order volume, on the basis of component data including the necessary lead time calculated by the necessary lead time calculation part, component production capacity of a component company, and days required for component transportation, and an order confirmation part configured to calculate a final lead time on the basis of the necessary lead time calculated by the necessary lead time calculation part and the safety lead time calculated by the safety lead time calculation part, and confirm an order quantity.

### TECHNICAL FIELD

The present disclosure relates to a component ordering system and a method therefor, the system and the method being capable of confirming an order quantity by managing component-specific lead time and safety stock in a component order quantity computation process.

### BACKGROUND ART

The production activities of a company basically require a system to supply a required quantity of required items at the required time, and a production management system such as Korean Patent Application Publication No. 10-2006-0007732 has been proposed.

In addition, recently, companies' production plans are organised when orders are placed usually through IT-based technology, and are carried out by overseeing the flow of a series of pieces of information, from the output/purchase of components to the delivery of goods. Various solutions, such as supply chain management (SCM), enterprise resource planning (ERP), material requirements planning (MRP), and customer relationship management (CRM), have been developed, and each company is building its own system using these technologies.

A system for ordering components calculates the order quantity, as one of the general production management activities of a company, through items, the required number of items calculated from a production plan, the current stock, and the undelivered stock. Herein, the lead time of components may be considered when calculating the required quantity of items calculated from the production plan. In addition, in order to have a stable flow of components, pieces of information required for production planning and ordering may be integrated and used to build an integrated system for automatic ordering.

In the meantime, a conventional component ordering system manages the lead time by component, but does not consider the situation of a component company. For example, in the case of an order to a component factory in Korea from an overseas vehicle factory, if the order-receiving company supplies components to multiple companies in Korea and other countries, it will take longer to supply components to the overseas factory because of the production capacity (capacity) of the component company and the order volume, and the accuracy of the lead time by component decreases.

In addition, safety stock is also called buffer stock. When the safety stock is calculated, it is necessary to handle the variability in production plans and material operation. However, only the arithmetic operations based on the quantity and lead time are applied and statistical techniques are not applied, thus resulting in a decrease in the accuracy of safety stock quantity. The above-described problem of the decrease in the accuracy of component-specific lead time and safety stock quantity may cause the uncertainty during the component distribution from a component company to a local area, which may cause over-ordering and stock shortage problems.

To solve these problems, there is a need for a method of calculating lead time by combining scenario setting and statistical techniques and mathematical optimization and of calculating safety stock by using statistical techniques, considering the production characteristics by component, the characteristics by component, the characteristics of distribution transportation by component, and the situation of a component company.

The foregoing is intended merely to aid in the understanding of the background of the present disclosure, and is not intended to mean that the present disclosure falls within the purview of the related art that is already known to those skilled in the art.

### DISCLOSURE

### Technical Problem

The present disclosure is directed to providing a component ordering system and a method therefor, wherein the lead time is calculated through statistical technique and optimization analysis so that different final lead times for respective components are calculated on the basis of an appropriate level of lead time and safety stock for each item, and the order quantity by component is adjusted to manage the stock quantity efficiently.

It will be appreciated by persons skilled in the art that technical objectives to be achieved in the present disclosure are not limited to the above-mentioned technical objectives and other technical objectives which are not described herein will be clearly understood from the following description.

### Technical Solution

In order to achieve the above objectives, according to the present disclosure, there is provided a component ordering system including: a necessary lead time calculation part configured to calculate, on the basis of prestored order data, a necessary lead time required for each component; a safety lead time calculation part configured to calculate a safety lead time satisfying customer order volume, on the basis of component data including the necessary lead time calculated by the necessary lead time calculation part, component production capacity of a component company, and days required for component transportation; and an order confirmation part configured to calculate a final lead time on the basis of the necessary lead time calculated by the necessary lead time calculation part and the safety lead time calculated by the safety lead time calculation part, and confirm an order quantity.

For example, the order data may include at least one selected from a group of data on the number of past split deliveries for each component, data on a warehousing time for each split delivery, and data on the number of required days.

For example, the necessary lead time calculation part may be configured to gather the prestored order data to generate order data distribution, and calculate, on the basis of the generated order data distribution, the necessary lead time required for each component.

For example, the necessary lead time calculation part may be configured to generate a plurality of scenarios through stratified sampling from the generated order data distribution, and calculate the necessary lead time required for each component, on the basis of the plurality of scenarios generated.

For example, the necessary lead time calculation part may be configured to calculate the necessary lead time required for each component according to a scenario satisfying the customer order volume among the plurality of scenarios generated.

For example, the safety lead time calculation part may be configured to calculate the order quantity on the basis of the component data, and calculate stock quantity through the calculated order quantity.

For example, the safety lead time calculation part may be configured to calculate the safety lead time according to the calculated stock quantity and daily production capacity of the component company.

For example, the order confirmation part may be configured to calculate the final lead time by adding the necessary lead time and the safety lead time.

For example, the order confirmation part may be configured to receive a pre-established production plan, and confirm the order quantity on the basis of the calculated final lead time and the received production plan.

In order to achieve the above objectives, according to the present disclosure, there is provided a component ordering method including: calculating, by a necessary lead time calculation part, a necessary lead time required for each component, on the basis of prestored order data; calculating, by a safety lead time calculation part, a safety lead time satisfying customer order volume, on the basis of component data including the necessary lead time, component production capacity of a component company, and days required for component transportation; calculating, by an order confirmation part, a final lead time on the basis of the necessary lead time calculated by the necessary lead time calculation part and the safety lead time calculated by the safety lead time calculation part; and confirming, by the order confirmation part, an order quantity on the basis of the calculated final lead time.

For example, in the calculating of the necessary lead time, the prestored order data may be gathered to generate order data distribution, and the necessary lead time required for each component may be calculated on the basis of the generated order data distribution.

For example, in the calculating of the necessary lead time, a plurality of scenarios may be generated through stratified sampling from the generated order data distribution, and the necessary lead time required for each component may be calculated on the basis of the plurality of scenarios generated.

For example, in the calculating of the necessary lead time, the necessary lead time required for each component may be calculated according to a scenario satisfying the customer order volume among the plurality of scenarios generated.

For example, in the calculating of the safety lead time, the order quantity may be calculated on the basis of the component data, and stock quantity may be calculated through the calculated order quantity.

For example, in the calculating of the final lead time, the final lead time may be calculated by adding the necessary lead time and the safety lead time.

### Advantageous Effects

According to a component ordering system and a method therefor according to the present disclosure, the lead time is calculated through statistical technique and optimization analysis so that different final lead times for respective components are calculated on the basis of an appropriate level of lead time and safety stock for each item, and the order quantity by component is adjusted to manage the stock quantity efficiently.

Effects that may be obtained from the present disclosure will not be limited to only the above-described effects. In addition, other effects which are not described herein will become apparent to those skilled in the art from the following description.

### DESCRIPTION OF DRAWINGS

FIG. 1 is a block diagram illustrating a component ordering system according to an embodiment of the present disclosure.

FIG. 2 is a diagram illustrating the concept of a necessary lead time and a safety lead time according to an embodiment of the present disclosure.

FIG. 3 is a block diagram more specifically illustrating a component ordering system according to an embodiment of the present disclosure.

FIG. 4 is a schematic diagram illustrating the uncertainty for each distribution section of a component and a plurality-of-scenarios generation module of a necessary lead time calculation part.

FIGS. 5 and 6 are schematic diagrams illustrating a safety lead time and safety stock calculation method of a safety lead time calculation part.

FIG. 7 is a flowchart illustrating the operation of a component ordering method according to an embodiment of the present disclosure.

FIG. 8 is a flowchart specifically illustrating processes A-1 and A-2 of FIG. 7.

### MODE FOR INVENTION

Hereinafter, embodiments described in the present specification will be described in detail with reference to the accompanying drawings. Throughout the drawings, like or similar elements are denoted by the same reference numerals, and a redundant description thereof will be omitted.

The suffixes “module” and “part” for elements used in the following description are given or used interchangeably only for the sake of easiness in making the specification, and do not have distinctive meanings or roles by themselves.

In describing an embodiment disclosed in the present specification, if it is determined that a detailed description of the known art related to the present disclosure makes the subject matter of the embodiment disclosed in the present specification unclear, the detailed description will be omitted. In addition, the accompanying drawings are only for easy understanding of the embodiment disclosed in the present specification, and do not limit the technical idea disclosed in the present specification. In addition, it is to be understood that the present disclosure includes all modifications, equivalents, and substitutions included in the spirit and the scope of the present disclosure. The terms “first”, “second”, etc. used in the specification can be used to describe various elements, but the elements are not to be construed as being limited to the terms. The terms are only used to differentiate one element from other elements.

It will be understood that when an element is referred to as being “coupled” or “connected” to another element, it can be directly coupled or connected to the other element or intervening elements may be present therebetween. In contrast, it will be understood that when an element is referred to as being “directly coupled” or “directly connected” to another element, there are no intervening elements present.

As used herein, the singular forms “a”, “an”, and “the” are intended to include the plural forms as well, unless the context clearly indicates otherwise.

In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Before describing the present disclosure, an order quantity (required quantity) calculation method will be described first. The order quantity (required quantity) may be computed as a value obtained by subtracting the sum of open PO, current stock, and work-in-process quantity from the sum n of order quantity (required quantity) by period and safety stock. Herein, the order quantity (required quantity) by period may refer to the order quantity of an orderer for a particular period, and the safety stock may refer to the quantity that is planned in advance and secured to prevent imbalanced quantity shortages due to fluctuations in product demand (sales volume). In addition, the open PO may refer to the quantity that has not yet been delivered after the orderer's order, and the work-in-process quantity may refer to the quantity that is currently being produced after the orderer's order. The order quantity (required quantity) by period described above may affect the lead time of components, which is the time (period) that it takes to produce goods.

In addition, the procurement of components is directly related to the issue of split deliveries of components of a cooperative company (component company). When a cooperative company is requested to supply components, the number of split deliveries and a period of split deliveries may vary depending on the cooperative company's component production capacity and the order volume. For example, when one order is made, multiple requests may be made or different dates of split deliveries may be set according to the component production capacity of the cooperative company.

According to an embodiment of the present disclosure, a component ordering system based on a production plan calculates the component-specific lead time and safety stock to minimize distribution costs and stock throughout the entire procurement process.

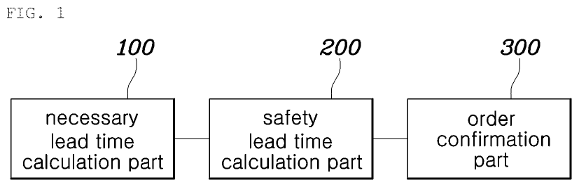

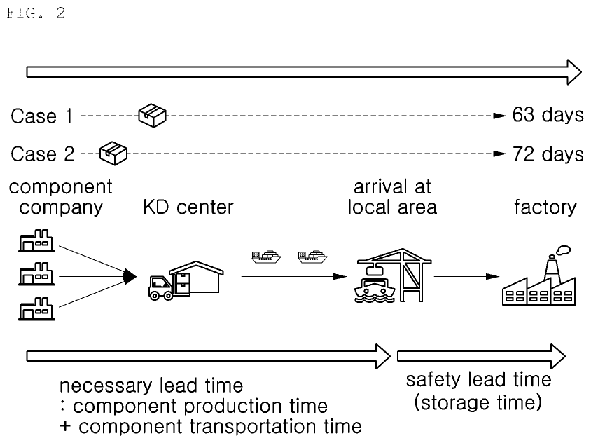

FIG. 1 is a block diagram illustrating a component ordering system according to an embodiment of the present disclosure. FIG. 2 is a diagram illustrating the concept of a necessary lead time and a safety lead time according to an embodiment of the present disclosure.

Referring to FIG. 1, the component ordering system may include a necessary lead time calculation part 100, a safety lead time calculation part 200, and an order confirmation part 300. FIG. 1 mainly shows the configuration related to the embodiment. The actual implementation of the component ordering system may include fewer or more elements.

First, the necessary lead time calculation part 100 may calculate, on the basis of prestored order data, the necessary lead time required for each component. Referring to FIG. 2, Case 1 and Case 2 represent 63 days and 72 days taken from a component company to a factory, respectively. Each period includes the time taken for the components to be transported from the component company to the KD center, the time taken for the components from the KD center to arrive at the local area, and the period of time taken for the components to be transported from the local area to the factory. Herein, the KD center refers to a distribution base that packages vehicle components procured domestically and internationally and distributes the vehicle components overseas. The necessary lead time is a period of time taken for the components from the component company to arrive at the local area, and is the sum of the component production time and the component transportation time. The safety lead time (storage time), which will be described later, may refer to the time taken for components to be transported from the local area to the factory.

More specifically, the necessary lead time calculation part 100 calculates the necessary lead time on the basis of order data. The order data may refer to the order quantity for the component company, which is prestored data, and may include data on the number of past split deliveries for each component, data on a warehousing time for each split delivery, and data on the number of required days. The above-described types of data are exemplary and are not necessarily limited thereto. The necessary lead time calculation part 100 may calculate that the greater the number of past split deliveries for each component, the later the warehousing time for each split delivery, and the greater the number of required days, the longer the necessary lead time.

The necessary lead time calculation method of the necessary lead time calculation part 100 will be described in detail.

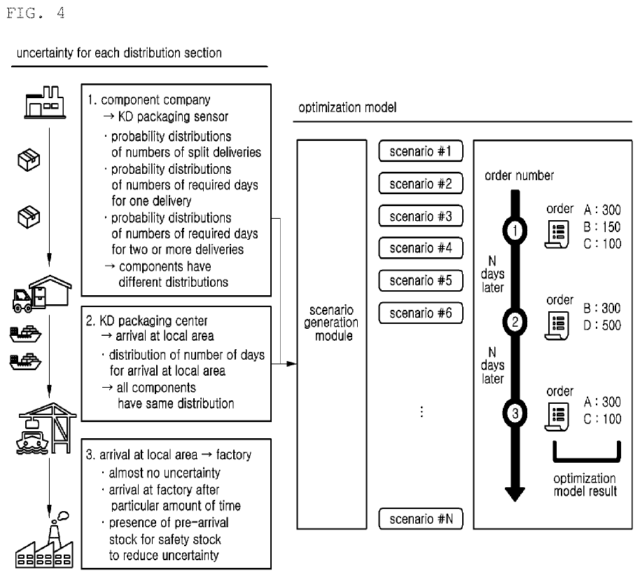

FIG. 4 is a schematic diagram illustrating the uncertainty for each distribution section of a component and a plurality-of-scenarios generation module of a necessary lead time calculation part 100.

First, the necessary lead time calculation part 100 gathers the order data including the data on the number of past split deliveries for each component, the data on the warehousing time for each split delivery, and the data on the number of required days described above. The gathered data may be data prestored in a database of a company, for example. The necessary lead time calculation part 100 generates order data distribution on the basis of the gathered order data. The necessary lead time calculation part 100 generates the order data distribution because of the existence of uncertainty in component distribution, and calculates, on the basis of the generated order data distribution, the necessary lead time required for each component. For example, during the time that a component is transported from the component company to the KD center, the uncertainty in component distribution is high, so components have different probability distributions of the numbers of split deliveries, probability distributions of the numbers of required days for one delivery, and probability distributions of the numbers of required days for two or more deliveries. Conversely, the uncertainty is reduced for the time taken for a component from the KD center to arrive at the local area, so all components may have the same distribution of the number of required days for arrival at the local area. In addition, there is little uncertainty during the time taken for a component to be transported to the factory after arrival at the local area, and the component arrives at the factory after a particular amount of time. Herein, in order to reduce the uncertainty in component distribution, there may be a pre-arrival stock in the form of safety stock.

Specifically, the necessary lead time calculation part 100 is the scenario generation module of FIG. 4, and may generate a plurality of scenarios through stratified sampling from the generated order data distribution. Stratified sampling is to stratify one population into homogeneous subpopulations and extract a sample by using a simple random sampling method according to the size of the subpopulations. Accordingly, the necessary lead time calculation part 100 extracts a sample by generating random numbers for the distribution of the number of split deliveries and the distribution of the number of required days on the basis of the order data distribution. For example, referring to FIG. 4, the necessary lead time calculation part 100 may select, among a plurality of scenarios generated on the basis of order data distribution, a scenario that satisfies a customer order volume of components A, B, and C according to a result of an optimization model, and may calculate the necessary lead time required for each component according to the selected scenario.

Herein, the optimization model result calculation logic is as follows. In a plurality of scenarios, the number of split deliveries of components for each order number of the customer, the number of required days, and the quantity required at the factory are predetermined values, and the optimization model may find the optimum value by continuously varying the customer order volume, which is a decision variable. In addition, once the quantity of components arriving at the factory on a particular date is determined, the quantity is compared to the quantity actually required by the factory determine there to whether is any dissatisfaction.

The formulas of the optimization model will be described later. First, the information required in advance to run the optimization model is as follows.

IWIPᵢⱼ may be set as the initial stock in process j of component i, Demandᵢₜ may be set as the desired stock quantity (=factory required quantity) of component i in period t, Demandᵢ may be set as the total desired stock quantity of component i, Demand_tᵢ may be set as the maximum number of t values with the final desired stock quantity of component i, SPCₛᵢₖ may be set as the number of split deliveries by order number k by component i by scenario s, SPRᵢₘₙ may be set as the warehousing ratio by warehousing number n by the number of split deliveries m by component i, DTAₛᵢₘₙₖ may be set as the date interval during ‘factory-KD center’ transportation by order number k by warehousing number n by the number of split deliveries m (=SPsi) by component i by scenario s, DTBₛₜ may be set as the date interval during ‘KD center→local area’ transportation by period t by scenario s, ODₜ may be set as the order number k on the order date t, ODₖ may be set as the order date t for the order number k, Cutoff_R may be set as a demand dissatisfaction ratio criterion, and Cutoff_N may be set as a criterion for the number of demand dissatisfaction scenarios.

To satisfy the optimization model, the requirements must be met are as follows. minimize Σₛᵢⱼₜ wipₛᵢⱼₜ needs to satisfy the formula for minimizing the stock by process, minimize Σₛⱼₜ slackₛⱼₜ needs to satisfy the formula for minimizing the number of production dissatisfaction cases, and minimize Σₛⱼₜ (T−t)·slackₛⱼₜ needs to satisfy the formula for satisfying the priority of a production dissatisfaction date. In addition, as variables determined in the optimization model, xₛᵢⱼₜ denotes the output quantity for process j of component i in period t by scenario s, wipₛᵢⱼₜ denotes the stock of component i in process j in period t by scenario s, ipᵢₜ denotes the number of orders for component i in period t, slackᵢₜ denotes the number of demand dissatisfaction cases for component i in period t, and overₛᵢ denotes whether the demand dissatisfaction ratio for component i by scenario s is equal to or above the cut off.

In the meantime, there are also limitations of the optimization model.

Specifically, Σₜ, xₛᵢⱼₜ+slackₛᵢₜ=Σₜ, Demandᵢₜ, ∀s, i, j, t may set the demand satisfaction limit (j=2, t′=cumulative values up to t, for example, t=2, t′=0, 1, 2), wipₛᵢⱼₜ=ipᵢₖ−xₛᵢⱼₜ, ∀s, i, j,t may set the WIP flow limit (t=0, j=0), wipₛᵢⱼₜ=IWIPᵢⱼ, ∀s, i, j, t may set the WIP flow limit (t=0, j>0), wipₛᵢⱼₜ=ipᵢₖ−xₛᵢⱼₜ, ∀s, i, j,t may set the WIP flow limit (t>0, j=0), wipₛᵢⱼₜ=−xₛᵢⱼₜ+Σ_{m, n, k∈DTA}_{ₛᵢₘₙₖ} SPRᵢₘₙ·x_{s,i,j-1,t-DTA}_{ₛᵢₘₙₖ}, ∀s, i, j, t may set the WIP flow limit (KD center) (t>0, j=1), wipₛᵢⱼₜ=wip_{s,i,j,t-1}−xₛᵢⱼₜ+Σ_{t′∈DTA}_{ₛᵢₘₙₖ}_{, DTB}_{ₛₜ} x_{s,i,j-1,t′}, ∀s, i, j, t may set the WIP flow limit (arrival at the local area) (t>0, j=2, t′: departure date with j=1), wipₛᵢⱼₜ=0, ∀s, i, j,t may set the initial stock limit (j=0, 1),

$$\frac{{\sum }_{t} {slack}_{sit}}{{Demand}_{i}} \geq Cutoff\_R * {over}_{s} ,$$

∀s, i may set a definition on whether the demand dissatisfaction ratio is exceeded, and Σₛ overₛ≤Cutoff_N, ∀i may set the limit on the number of demand dissatisfaction scenarios.

Next, the safety lead time calculation part 200 may calculate the safety lead time on the basis of component data. The safety lead time is a quantifiable period of time during which the stock quantity satisfies the production for N days. The component data includes the necessary lead time calculated by the necessary lead time calculation part 100, the component production capacity of the component company, and the days required for component transportation, but these are exemplary and are not necessarily limited thereto.

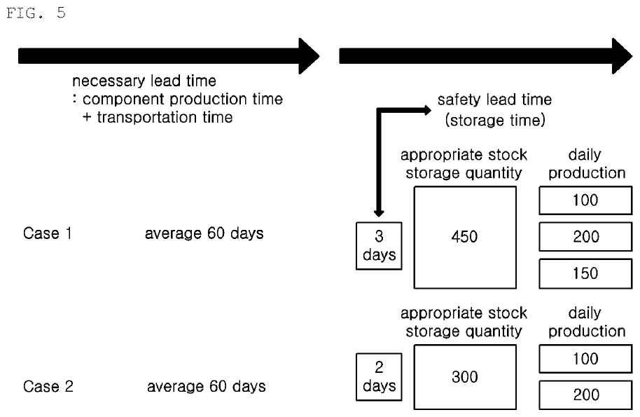

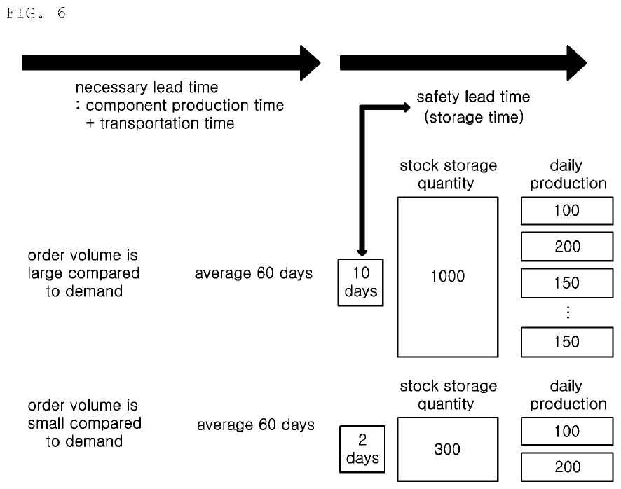

FIGS. 5 and 6 are schematic diagrams illustrating a safety lead time and safety stock calculation method of a safety lead time calculation part 200.

Referring to FIGS. 5 and 6, the safety lead time calculation part 200 first calculate the order quantity on the basis of the component data, and if the calculated order quantity and the number of days required for components to be transported are determined, the stock quantity by date may be calculated. Specifically, the safety lead time calculation part 200 may map the calculated stock quantity by date to daily production capacity information of the component company to calculate how many days' work of production quantity is currently stored in stock. Accordingly, the safety lead time may be calculated according to the calculated stock quantity and the daily production capacities of the component company. In Case 1 of FIG. 5, when the stock quantity calculated as the appropriate stock storage quantity is 450 and daily production capacities (productions) are 100, 200, and 150, respectively, the safety lead time is 3 days. In addition, in Case 2, when the stock quantity calculated as the appropriate stock storage quantity is 300 and daily production capacities (productions) are 100 and 200, respectively, the safety lead time is 2 days. Herein, a component-specific safety lead time value is used to draw a distribution, and according to the distribution, the average or 90th percentile may be defined as the component-specific safety lead time. In addition, as shown in FIG. 6, when the order volume is large compared to the demand, the stock quantity calculated as the appropriate stock storage quantity is 1000 and the safety lead time may be increased to 10 days according to the daily production capacity. Conversely, when the order volume is small compared to the demand, the calculated stock quantity is 300 and the safety lead time may be reduced to 2 days according to the daily production capacity.

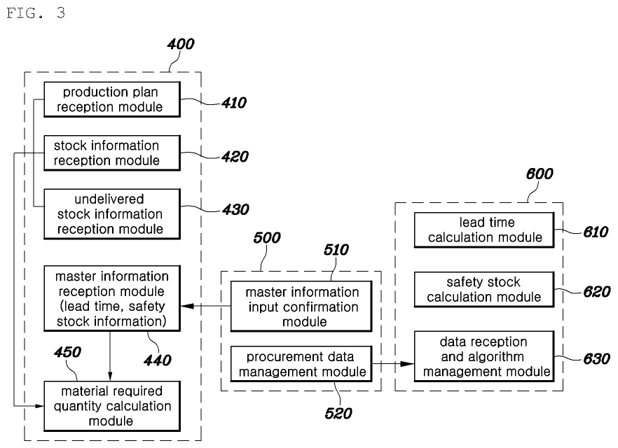

A more detailed representation of the component ordering system of FIG. 1 including the necessary lead time calculation part 100 and the safety lead time calculation part 200 described above and the order confirmation part 300, which will be described later, is shown in FIG. 3.

FIG. 3 is a block diagram more specifically illustrating a component ordering system according to an embodiment of the present disclosure.

Referring to FIG. 3, a first part 400 may include a production plan reception module 410, a stock information reception module 420, an undelivered stock information reception module 430, a master information reception module 440, and a material required quantity calculation module 450. A second part 500 may include a master information input confirmation module 510 and a procurement data management module 520. A third part 600 may include a lead time calculation module 610, a safety stock calculation module 620, and a data reception and algorithm management module 630. The necessary lead time calculation part 100 and the safety lead time calculation part 200 described above may be included in the lead time calculation module 610, and the order confirmation part 300 may be included in the first module. According to an embodiment of the present disclosure, the procurement data management module 520 may transmit data to the data reception and algorithm management module 630, and the master information reception module 440 may transmit master information including a necessary lead time, a safety lead time, and safety stock information to the master information reception module 440. The production plan reception module 410, the stock information reception module 420, and the undelivered stock information reception module 430 may transmit a production plan, stock information, and undelivered stock information to the material required quantity calculation module 450, and the master information reception module 440 may transmit master information to the material required quantity calculation module 450.

Lastly, the order confirmation part 300 may calculate the final lead time on the basis of the necessary lead time calculated by the necessary lead time calculation part 100 and the safety lead time calculated by the safety lead time calculation part 200 and may confirm the order quantity. The order confirmation part 300 may receive a pre-established production plan, and may calculate the final lead time by adding the necessary lead time and the safety lead time. Eventually, the order confirmation part 300 may use the final lead time calculated for an individual component to confirm the final order quantity on the basis of the production plan for the corresponding period.

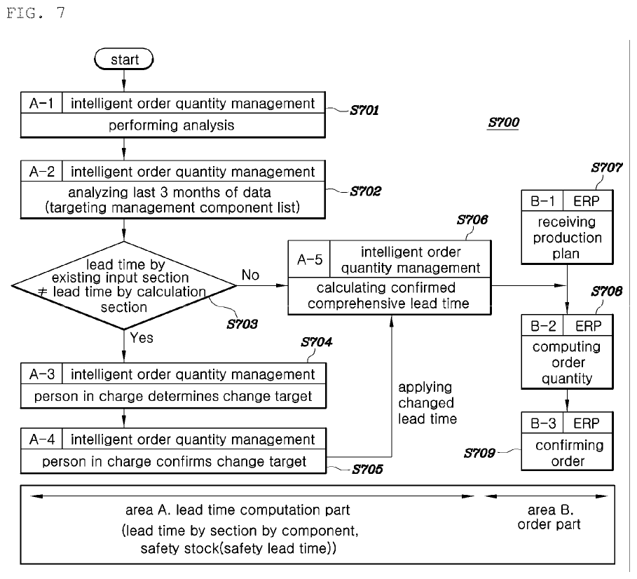

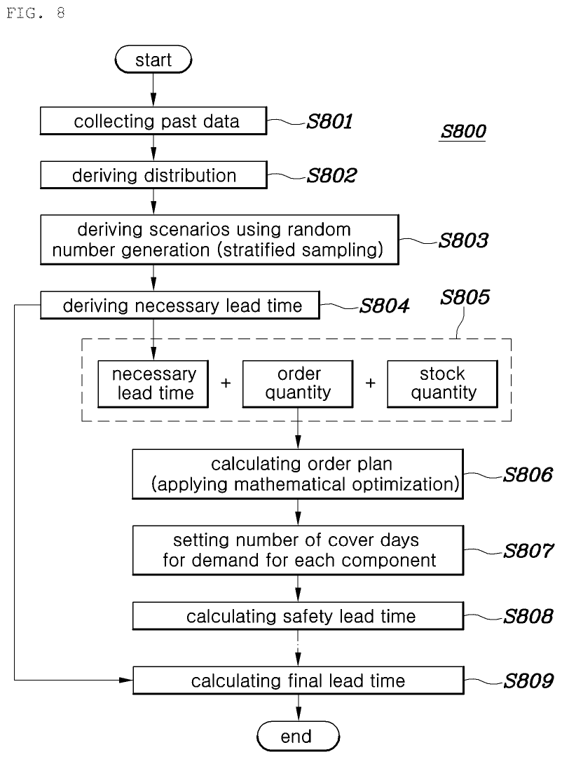

On the basis of the above-described component ordering system, a component ordering method according to an embodiment will be described with reference to FIGS. 7 and 8.

FIG. 7 is a flowchart S700 illustrating the operation of a component ordering method according to an embodiment of the present disclosure.

First, area A is a lead time computation part, and steps S701 to S706 show an intelligent quantity management flowchart. In addition, area B is an order part and may be handled by enterprise resource planning (ERP). The above-described order confirmation part 300 may include enterprise resource planning.

First, the lead time calculation module 610 performs an analysis of prestored order data in step S701. The lead time calculation module 610 may analyze the last three months of data as past order data in step S702, and may determine whether the lead time by existing input section and the lead time by calculation section match in step S703. When the lead time by existing input section and the lead time by calculation section do not match in step S703 (YES), the person in charge may determine the change lead time in step S704, and the person in charge may confirm the change lead time in step S705. The changed lead time may be applied when the final lead time is calculated. Conversely, when the lead time by existing input section and the lead time by calculation section match in step S703 (NO), the lead time calculation module 610 may calculate the confirmed final lead time in step S706. The enterprise resource planning may receive the pre-established production plan and the final lead time in step S707, and may compute the order quantity on the basis of the final lead time and the received production plan in step S708. Afterward, the enterprise resource planning may confirm the computed order quantity as the order quantity in step S709.

FIG. 8 is a flowchart S800 specifically illustrating processes A-1 and A-2 of FIG. 7.

Referring to FIG. 8, first, the necessary lead time calculation part 100 may collect prestored past order data in step S801. Afterward, the necessary lead time calculation part 100 may gather prestored order data to generate order data distribution in step S802, and may generate a plurality of scenarios through stratified sampling from the order data distribution in step S803. Afterward, the necessary lead time required for each component may be calculated on the basis of the plurality of scenarios generated in step S804. The safety lead time calculation part 200 may calculate the order quantity on the basis of component data in step S805. In addition, the safety lead time calculation part 200 may calculate the stock quantity according to the calculated order quantity and calculate an order plan in step S806, and may set the number of cover days to satisfy the demand for each component in step S807. The safety lead time calculation part 200 may set the number of cover days depending on how much demand is covered according to the production plan and the calculated stock quantity. Afterward, the safety lead time calculation part 200 may calculate the safety lead time by dividing the calculated stock quantity by the daily production capacity of the component company in S808. Afterward, the order confirmation part 300 may calculate the final lead time by adding the necessary lead time and the safety lead time in step S809.

According to the embodiments of the present disclosure described above, the lead time is calculated through statistical technique and optimization analysis so that different final lead times for respective components are calculated on the basis of an appropriate level of lead time and safety stock for each item, and the order quantity by component is adjusted to manage the stock quantity efficiently.

Although a particular embodiment of the present disclosure has been described for illustrative purposes, those skilled in the art will appreciate that various modifications, additions, and substitutions are possible, without departing from the technical idea of the disclosure as disclosed in the accompanying claims.

### DESCRIPTION OF THE REFERENCE NUMERALS IN THE DRAWINGS

100: necessary lead time calculation part 200: safety lead time calculation part
300: order confirmation part 400: first part
410: production plan reception module 420: stock information reception module
430: undelivered stock information reception module 440: master information reception module
450: material required quantity calculation module 500: second part
510: master information input confirmation module 520: procurement data management module
600: third part 610: lead time calculation module
620: safety stock calculation module
630: data reception and algorithm management module

1. A component ordering system, comprising:
a necessary lead time calculation part configured to calculate, based on prestored order data, a necessary lead time required for each component;
a safety lead time calculation part configured to calculate a safety lead time satisfying customer order volume, based on component data including the necessary lead time calculated by the necessary lead time calculation part, component production capacity of a component company, and days required for component transportation; and
an order confirmation part configured to calculate a final lead time based on the necessary lead time calculated by the necessary lead time calculation part and the safety lead time calculated by the safety lead time calculation part, and confirm an order quantity.

2. The component ordering system of claim 1, wherein the order data includes at least one selected from a group of data on the number of past split deliveries for each component, data on a warehousing time for each split delivery, and data on the number of required days.

3. The component ordering system of claim 1, wherein the necessary lead time calculation part is configured to gather the prestored order data to generate order data distribution, and calculate, based on the generated order data distribution, the necessary lead time required for each component.

4. The component ordering system of claim 3, wherein the necessary lead time calculation part is configured to generate a plurality of scenarios through stratified sampling from the generated order data distribution, and calculate the necessary lead time required for each component, based on the plurality of scenarios generated.

5. The component ordering system of claim 4, wherein the necessary lead time calculation part is configured to calculate the necessary lead time required for component according to a scenario satisfying the each customer order volume among the plurality of scenarios generated.

6. The component ordering system of claim 1, wherein the safety lead time calculation part is configured to calculate the order quantity based on the component data, and calculate stock quantity through the calculated order quantity.

7. The component ordering system of claim 6, wherein the safety lead time calculation part is configured to calculate the safety lead time according to the calculated stock quantity and daily production capacity of the component company.

8. The component ordering system of claim 1, wherein the order confirmation part is configured to calculate the final lead time by adding the necessary lead time and the safety lead time.

9. The component ordering system of claim 1, wherein the order confirmation part is configured to receive a pre-established production plan, and confirm the order quantity based on the calculated final lead time and the received production plan.

10. A component ordering method, comprising:
calculating, by a necessary lead time calculation part, a necessary lead time required for each component, based on prestored order data;
calculating, by a safety lead time calculation part, a safety lead time satisfying customer order volume, based on component data including the necessary lead time, component production capacity of a component company, and days required for component transportation;
calculating, by an order confirmation part, a final lead time based on the necessary lead time calculated by the necessary lead time calculation part and the safety lead time calculated by the safety lead time calculation part; and
confirming, by the order confirmation part, an order quantity based on the calculated final lead time.

11. The component ordering method of claim 10, wherein in the calculating of the necessary lead time,
the prestored order data is gathered to generate order data distribution, and the necessary lead time required for each component is calculated based on the generated order data distribution.

12. The component ordering method of claim 11, wherein in the calculating of the necessary lead time, a plurality of scenarios are generated through stratified sampling from the generated order data distribution, and the necessary lead time required for each component is calculated based on the plurality of scenarios generated.

13. The component ordering method of claim 12, wherein in the calculating of the necessary lead time, the necessary lead time required for each component is calculated according to a scenario satisfying the customer order volume among the plurality of scenarios generated.

14. The component ordering method of claim 10, wherein in the calculating of the safety lead time, the order quantity is calculated based on the component data, and stock quantity is calculated through the calculated order quantity.

15. The component ordering method of claim 10, wherein in the calculating of the final lead time, the final lead time is calculated by adding the necessary lead time and the safety lead time.
